(19) United States
(12) Patent Application Publication
(10) Pub. No.: US 2026/0326073 A1
(43) Pub. Date: Oct. 22, 2026

(54) System for Plasma Methane Pyrolysis

(71) Applicant: Radom Corporation, West Allis, WI (US)

(72) Inventors: Velibor Pikelja, Milwaukee, WI (US); Ian McKinney, Mequon, WI (US); Jovan Jevtic, West Allis, WI (US)

(21) Appl. No.: 19/654,993

(22) Filed: Apr. 22, 2026

Related U.S. Application Data
(60) Provisional application No. 63/792,721, filed on Apr. 22, 2025.

(51) Int. Cl. B01J 19/08; C01B 3/24

(52) U.S. Cl. CPC B01J 19/088; C01B 3/24; B01J 2219/0801; B01J 2219/0845; B01J 2219/0898; C01B 2203/0272; C01B 2203/0861; C01B 2203/1241

(57) ABSTRACT

An apparatus for methane pyrolysis or the like pyrolyzes methane using a plasma induced by a microwave source. A nonconductive mirror, such as a Bragg mirror, is positioned between the microwave source and the plasma allowing the passage of microwave energy into the plasma but blocking blackbody radiation emitted by carbon particles at plasma temperatures.

### CROSS REFERENCE TO RELATED APPLICATION

This application claims the benefit of U.S. provisional application 63/792,721 filed Apr. 22, 2025, and hereby incorporated in its entirety by reference.

### BACKGROUND OF THE INVENTION

The present invention relates to systems for converting methane into hydrogen using plasma, and in particular to a system employing an efficient microwave plasma generator.

Hydrogen may play an important environmental role as an energy carrier and storage mechanism for renewable energy sources like wind, solar, and hydroelectric generation. A transition of the economy to the use and production of hydrogen, however, requires a concurrent development of a hydrogen distributing and consuming infrastructure and interim sources of economically viable hydrogen.

Currently commercial hydrogen is produced using “steam methane reforming” which undesirably produces 7 kg of carbon dioxide for every kilogram of hydrogen generated, necessitating subsequent carbon capture steps to be environmentally sound.

An alternative to steam methane reforming is “plasma methane pyrolysis” where high-energy plasma breaks down methane in the absence of oxygen into hydrogen and solid carbon, the latter of which can be readily sequestered and used for other industrial purposes.

Current high-powered plasma torches suitable for such purpose may use electrodes for generating a plasma arc and are subject to electrode wear and contamination of the plasma. An alternative plasma generator is described in U.S. Pat. Nos. 9,706,635 and 9,491,841, assigned to the assignee of the present application and hereby incorporated by reference. This design employs microwave energy stimulating a resonant dielectric ring, the latter generating a concentrated electrical field breaking down a carrier gas in the plasma. This approach eliminates the need for arc-sustaining electrodes and overcomes power limitations associated with conventional conductive loop coil designs.

While the above-described microwave plasma torch provide substantial advantages in generating plasma, when torches of this type are used for pyrolysis of methane, the resulting solid carbon particles produce intense blackbody radiation reducing power efficiency and potentially damaging the plasma torch.

### SUMMARY OF THE INVENTION

The present invention provides a plasma methane pyrolysis system advantageously using a high-power microwave plasma torch by employing a mirror that is transparent to microwaves but reflective to the blackbody radiation emitted by carbon particles at plasma temperatures. A monolithic resonator design joins multiple dielectric rings in a continuous body of dielectric material, greatly simplifying the design and preserving the concentrating power of the rings while hardening the dielectric rings against heat damage by removing polymer or other nonconducting spacer elements previously used.

These particular objects and advantages may apply to only some embodiments falling within the claims and thus do not define the scope of the invention.

### BRIEF DESCRIPTION OF THE DRAWINGS

FIG. 1 is an elevational cross-section of a microwave plasma torch modified to regenerate blackbody radiation; and

FIG. 2 perspective view of a dielectric ring used in the microwave plasma torch of FIG. 1 providing a high-temperature monolithic resonator structure.

### DETAILED DESCRIPTION OF THE PREFERRED EMBODIMENT

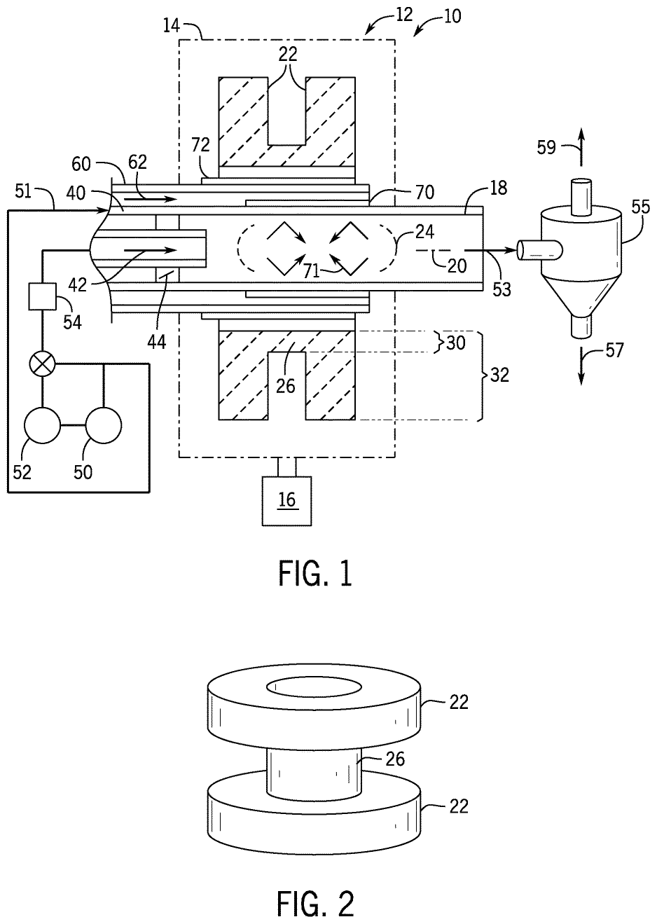

Referring now to FIG. 1, a plasma methane pyrolysis system 10 may provide a plasma torch 12 providing a waveguide cavity 14 excited by a microwave source 16. Additional details of the waveguide cavity 14 and microwave source 16 may be found in US patent 11,956, 882, assigned to the assignee of the present application and hereby incorporated by reference.

A plasma tube 18, centered in the waveguide cavity 14, extends along an axis 20 and is surrounded by one or more dielectric resonators 22, each being, in one embodiment, an annular ring of dielectric material symmetric and coaxially about the axis 20. The waveguide cavity 14, as coupled to the microwave source 16, promotes cyclic current flow about the axis 20 within the dielectric resonators 22 producing an intense electrical field generating a plasma 24 within the plasma tube 18.

Referring now to FIG. 2, the dielectric resonators 22 are desirably constructed of a material having a quality factor of greater than 100, an electrical resistivity greater than 1×10¹⁰ Ωcm, a dielectric constant with a loss tangent of less than 0.01, and a dielectric constant (relative permittivity) greater than five. It will be appreciated that an arbitrary number of dielectric resonators may be arrayed along the plasma tube 18 with corresponding increases in the height of the of the plasma 24, for example, when higher power plasma torches are required. Nonlimiting examples of dielectric material include alumina (Al2O3) or calcium titanate (CaTiO3).

The dielectric resonators 22 may be separated from each other by one or more short tubular spacer elements 26 formed of the same material as the dielectric resonators 22 and preferably formed integrally with the dielectric resonators 22 radially symmetric about a common axis 20. The spacer elements 26 may have a central bore equal to that of the dielectric resonators 22 in order to receive the plasma tube 18, but an outer diameter substantially less than that of the dielectric resonators 22. More specifically, a radial extent 30 of the spacer elements 26 measured perpendicular to the axis 20 will be substantially less than the radial extent 32 of the dielectric resonators 22. This serves to concentrate induced current flow in the dielectric resonators 22 to produce corresponding concentrate electrical fields in the plasma tube 18 providing peak field gradients necessary to generate plasma. In this respect, the radial extent 30 maybe be less than half of the radial extent 32 and typically the radial extent 30 will be less than 25% or 10% of the radial extent 32.

The process of generating plasma through a concentrated yet highly uniform electrical field within a dielectric resonator is described in more detail in U.S. Pat. Nos. 9,706,635 and 9,491,841, assigned to the assignee of the present application and cited above and hereby incorporated by reference.

An inner tube 40, for example, of quartz or borosilicate glass may fit coaxially within the plasma tube 18 to provide a center gas 42 for introduction within the dielectric resonators 22 where plasma 24 will be formed. Methane 50 is introduced as carrier gas 51 passing between the outer wall of the inner tube 40 and the plasma tube 18. Inner tube 40 may be supported against the inner surface of the plasma tube 18 by a swirl vane 44 imparting a swirling motion to carrier gas 51. The center gas 42 may be methane 50 at low flow rate during use or another gas such as argon 52 during an initial igniting of plasma 24, for example, using a spark igniter 54. When methane 50 is introduced into the plasma 24, an outflow 53 of combined hydrogen and solid carbon black is produced which may be separated, for example, by a cyclonic separator 55 to produce separate streams of solid particulate carbon black 57 and hydrogen 59.

An outer tube 60 may pass coaxially around the plasma tube 18 between the plasma tube 18 and the inner bore of the dielectric resonators 22 also receiving a cooling gas 62.

An outer surface of the plasma tube 18 proximate to the plasma 24 may support a dielectric reflector 70 (Bragg mirror). In some embodiments a similar dielectric reflector 72 may also be placed on the inner or outer surfaces of the outer tube 60 in the same vicinity. Such a dielectric reflector 70 is preferably constructed of an electrically non-conductive material so as to prevent shielding of the microwave frequency electromagnetic fields generated by the dielectric resonators 22. Otherwise the dielectric reflector 70 is configured to reflect light 71 within the range of the blackbody radiation at plasma temperatures (1000 °C-6000 °C) of carbon particles generated by the methane pyrolysis. In particular, the dielectric reflector relies on constructive and destructive interference between light 71 generated by the plasma 24 passing through multiple alternating layers of materials with different refractive indices whose interfaces promote reflections at a proper phase to cancel outgoing light. Other Bragg type reflectors, for example, relying on thickness variations, are also contemplated provided they allow for the passage of electromagnetic microwave radiation but block the immediate light 71 of the carbon particles.

It is expected that the dielectric resonator 22 will reflect at least 10% and preferably 30% or more or 50% or more of the visible light 71 from the blackbody radiation of the carbon particles and will block less than 10% of the microwave energy or preferably less than 5% or less than 1% of the microwave energy.

By reflecting the blackbody radiation from the carbon particles, the dielectric resonators 22 are protected from excess heat buildup and the efficiency of the pyrolysis is promoted by retaining captured light energy.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A plasma methane pyrolysis apparatus comprising:
a tubular channel adapted to receive methane gas;
a source of microwave energy positioned to direct microwaves into the tubular channel to induce a plasma within the tubular channel in the methane gas; and
an electrically nonconductive dielectric mirror positioned between the plasma and the source of microwave energy preferentially passing microwave energy and blocking blackbody radiation from carbon particles in the plasma.

2. The plasma methane pyrolysis apparatus of claim 1 wherein the source of microwave energy is a dielectric resonator surrounding a portion of the tubular channel and the electrically nonconductive dielectric mirror is a sleeve surrounding the tubular channel between the tubular channel and the dielectric resonator.

3. The plasma methane pyrolysis apparatus of claim 2 further including a microwave generator and a waveguide conducting microwave energy from the waveguide to the dielectric resonator.

4. The plasma methane pyrolysis apparatus of claim 2 wherein the dielectric resonator is a monolithic ring about an axis aligned with an axis of the tubular channel and providing a circumferential notch position between its axial ends spacing apart opposed annular portions.

5. The plasma methane pyrolysis apparatus of claim 1 wherein the electrically nonconductive dielectric mirror is a Bragg mirror.

6. The plasma methane pyrolysis apparatus of claim 1 wherein the tubular channel provides a central methane conductor tube axially aligned with a plasma tube of greater diameter, the plasma tube providing a sheath gas passageway between an outer surface of the central methane conductor tube and an inner surface of the plasma tube for receiving a sheath gas.

7. The plasma methane pyrolysis apparatus of claim 6 further providing a shield tube surrounding and axially aligned with the plasma tube and central methane conductor tube providing a sheath gas passageway between the outer surface of the plasma tube and the inner surface of the shield tube for receiving a sheath gas.

8. The plasma methane pyrolysis apparatus of claim 7 wherein the electrically nonconductive dielectric mirror is supported by at least one of the shield tube and the plasma tube blocking blackbody radiation directed toward the source of microwave energy.

9. The plasma methane pyrolysis apparatus of claim 6 further including a swirl vane placed between the central methane conductor tube and the plasma tube for imparting a helical swirl to sheath gas passing between the central methane conductor tube and the plasma tube.

10. The plasma methane pyrolysis apparatus of claim 1 including a separator receiving pyrolyzed gas from the tubular channel to separate carbon particulates from the pyrolyzed gas.

11. A method of methane pyrolysis comprising:
(a) introducing methane gas through a tubular channel;
(b) directing microwave energy from a microwave energy source into the tubular channel to induce a plasma within the tubular channel in the methane gas; and
(c) blocking blackbody radiation from carbon particles in the plasma using an electrically nonconductive dielectric mirror positioned between the plasma and the source of microwave energy.

12. The method of claim 11 wherein the source of microwave energy is a dielectric resonator surrounding a portion of the tubular channel and the electrically nonconductive dielectric mirror is a sleeve surrounding the tubular channel between the tubular channel and the dielectric resonator.

13. The method of claim 12 further including a microwave generator and a waveguide conducting microwave energy from the waveguide to the dielectric resonator.

14. The method of claim 12 wherein the dielectric resonator is a monolithic ring about an axis aligned with an axis of the tubular channel and providing a circumferential notch position between its axial ends spacing apart opposed annular portions.

15. The method of claim 12 wherein the electrically nonconductive dielectric mirror is a Bragg mirror.

16. The method of claim 11 wherein the tubular channel provides a central methane conductor tube axially aligned with a plasma tube of greater diameter, the plasma tube providing a sheath gas passageway between an outer surface of the central methane conductor tube and an inner surface of the plasma tube for receiving a sheath gas.

17. The method of claim 16 further providing a shield tube surrounding and axially aligned with the plasma tube and central methane conductor tube providing a sheath gas passageway between the outer surface of the plasma tube and the inner surface of the shield tube for receiving a sheath gas.

18. The method of claim 17 wherein the electrically nonconductive dielectric mirror is supported by at least one of the shield tube and the plasma tube blocking blackbody radiation directed toward the source of microwave energy.

19. The method of claim 16 further including a swirl vane placed between the central methane conductor tube and the plasma tube for imparting a helical swirl to sheath gas passing between the central methane conductor tube and the plasma tube.

20. The method of claim 11 including a separator receiving pyrolyzed gas from the tubular channel to separate carbon particulates from the pyrolyzed gas.
